(19) United States
(12) Patent Application Publication
(10) Pub. No.: US 2024/0405585 A1
(43) Pub. Date: Dec. 5, 2024

(54) POWER DELIVERY APPARATUS

(71) Applicant: Samsung Electronics Co., Ltd., Suwon-si (KR)

(72) Inventors: Keonwoo KIM, Suwon-si (KR); Moonyoung KIM, Suwon-si (KR)

(21) Appl. No.: 18/608,390

(22) Filed: Mar. 18, 2024

Related U.S. Application Data
(63) Continuation of application No. PCT/KR2024/003006, filed on Mar. 8, 2024.

(30) Foreign Application Priority Data
May 30, 2023 (KR) 10-2023-0069500

(51) Int. Cl. H02J 7/00

(52) U.S. Cl. CPC H02J 7/00712; H02J 2207/20; H02J 2207/30

(57) ABSTRACT

Disclosed is a power delivery apparatus for transmitting power through a universal serial bus (USB). The power delivery apparatus may include a driving circuit configured to output an internal operating voltage by an induced electromotive force due to a current flowing through a primary coil. The driving circuit may include secondary coils having different winding directions and may be configured such that a plurality of rectification circuits are coupled in series.

### CROSS REFERENCE TO RELATED APPLICATIONS

This application is a continuation of International Application No. PCT/KR2024/003006 designating the United States, filed on Mar. 8, 2024, in the Korean Intellectual Property Receiving Office, claiming priority to Korean Patent Application No. 10-2023-0069500, filed on May 30, 2023, in the Korean Intellectual Property Office, the disclosures of each of which are incorporated by reference herein in their entireties.

### BACKGROUND

### Field

The disclosure relates to a power delivery apparatus that transfers power over a universal serial bus (USB).

### Description of Related Art

A power delivery (PD) apparatus may utilize a type-C USB to supply power for charging a target device electrically coupled thereto. The PD apparatus may increase its maximum power output based on a USB extension standard to enable fast charging.

The PD apparatus may include a direct current to direct current (DC/DC) converter. The DC/DC converter may step up (e.g., increase) or step down (e.g., decrease) an input voltage to provide an output voltage. The PD apparatus may provide power for charging various types of target devices. The target devices may include most electronic devices having secondary batteries therein, such as portable communication devices (e.g., smartphones), computer devices, portable multimedia devices, portable medical devices, cameras, wearable devices, or home appliances.

The PD apparatus may identify target devices electrically coupled thereto by a type-C USB and provide different levels of voltages for charging for each of the identified target devices. For example, the PD apparatus may provide a variable voltage in the range of 5 V to 48 V and may provide a maximum output power of up to 240 watts (W).

In a power delivery apparatus that provides a wide output range of charging supply voltage Vo, the power that a regulator must handle may increase in order to supply a constant internal operating voltage Vcc in consideration of the variable charging supply voltage Vo.

### SUMMARY

According to an example embodiment of the disclosure, a power delivery apparatus may comprise: a primary-side input rectification circuit configured such that a current flows through a primary coil by alternately operating at least two switching elements according to a magnitude of a charging supply voltage to be obtained, a first driving circuit configured to output the charging supply voltage by an induced electromotive force based on a current flowing through the primary coil and a second driving circuit configured to output an internal operating voltage by the induced electromotive force based on the current flowing through the primary coil, wherein the second driving circuit includes secondary coils having different winding directions, and is configured such that a plurality of rectification circuits are coupled in series.

According to an example embodiment of the disclosure, a power delivery apparatus by a USB may comprise: a flyback converter configured to use an input voltage to output a charging supply voltage variable within a specified range, and an operating voltage having a constant magnitude, and a flyback converter chip, comprising circuitry, configured to use the operating voltage to drive the flyback converter.

According to an example embodiment of the disclosure, the flyback converter may comprise: a transformer including a primary coil and a plurality of secondary coils, and rectification circuits, each having substantially the same electrical structure electrically connected to each of the plurality of secondary coils.

According to an example embodiment of the disclosure, the flyback converters may be configured such that voltages obtained in parallel by the two rectification circuits electrically connected to two secondary coils having the same number of turns and opposite winding directions, among the plurality of secondary coils are added to be output as the operating voltage.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a circuit diagram illustrating an example power delivery apparatus according to various embodiments;

FIG. 2A is a circuit diagram illustrating an example operation when a first switching element is turned on in a power delivery apparatus according to various embodiments;

FIG. 2B is a circuit diagram illustrating an example operation when a second switching element is turned on in a power delivery apparatus according to various embodiments;

FIG. 3A includes example waveform diagrams of an operation simulation for obtaining a low charging supply voltage in a power delivery apparatus according to various embodiments;

FIG. 3B includes example waveform diagrams of an operation simulation for obtaining a high charging supply voltage in a power delivery apparatus according to various embodiments; and

FIGS. 4, 5, 6, and 7 are circuit diagrams illustrating an example power delivery apparatus according to various embodiments.

### DETAILED DESCRIPTION

Hereinafter, various example embodiments of the disclosure will be described in greater detail with reference to the drawings so that those skilled in the art to which the disclosure pertains may easily practice the disclosure. However, the disclosure may be implemented in various different forms and is not limited to the example embodiments described herein. With regard to description of drawings, the same or similar reference numerals may be used for the same or similar components. Further, in the drawings and related descriptions, descriptions of well-known functions and configurations may be omitted for clarity and brevity.

According to an embodiment of the disclosure, a driving circuit designed to constantly supply an internal operating voltage Vcc in a power delivery apparatus having a wide output voltage range may be provided.

According to an embodiment of the disclosure, a power delivery apparatus that provides a charging supply voltage Vo in a wide output range may stably supply a constant internal operating voltage Vcc regardless of the charging supply voltage Vo while reducing voltage stress of a capacitor.

The technical problems to be addressed in the disclosure are not limited to those mentioned above, and other technical problems not mentioned herein may be understood from the example embodiments of the disclosure by those skilled in the art to which the disclosure pertains.

The effects that may be obtained from the example embodiments of the disclosure may be clearly understood by those skilled in the art to which the example embodiments of the disclosure belong from the following description. In other words, any unintended effects of implementing the example embodiments of the disclosure may also be understood from the example embodiments of the disclosure by those skilled in the art.

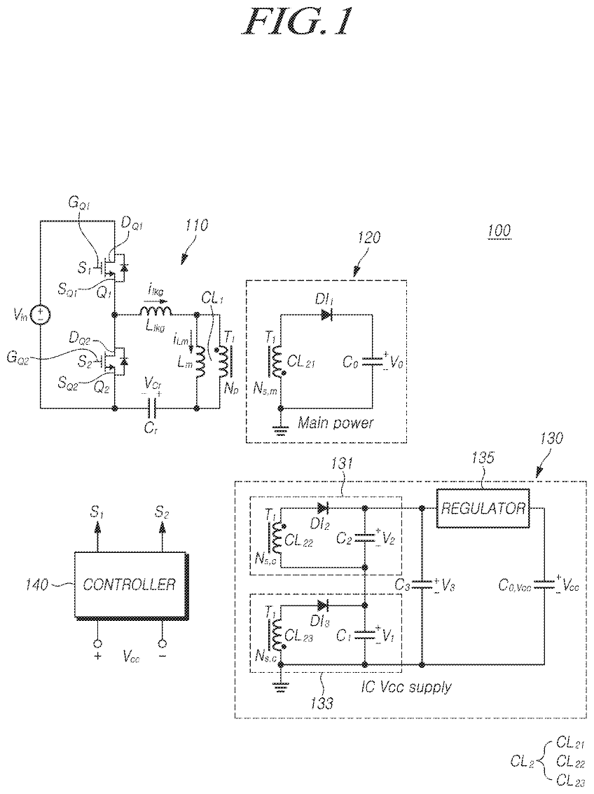

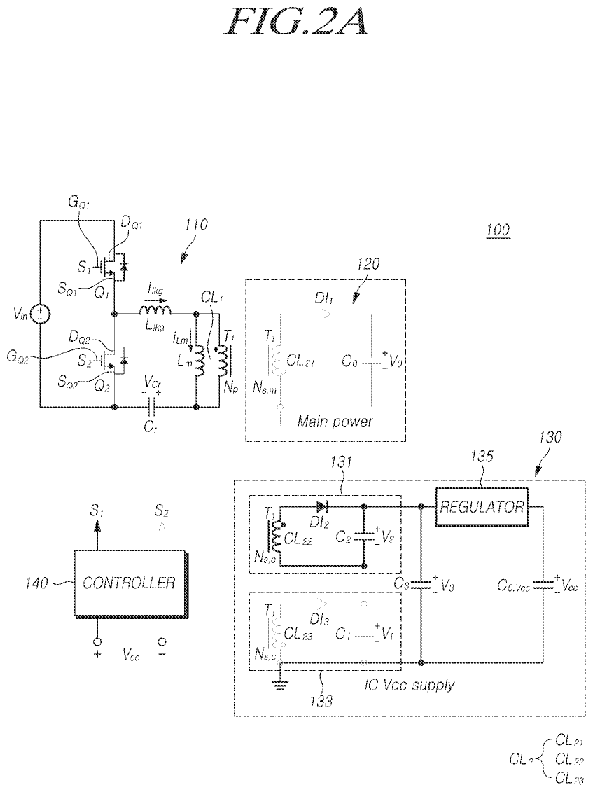

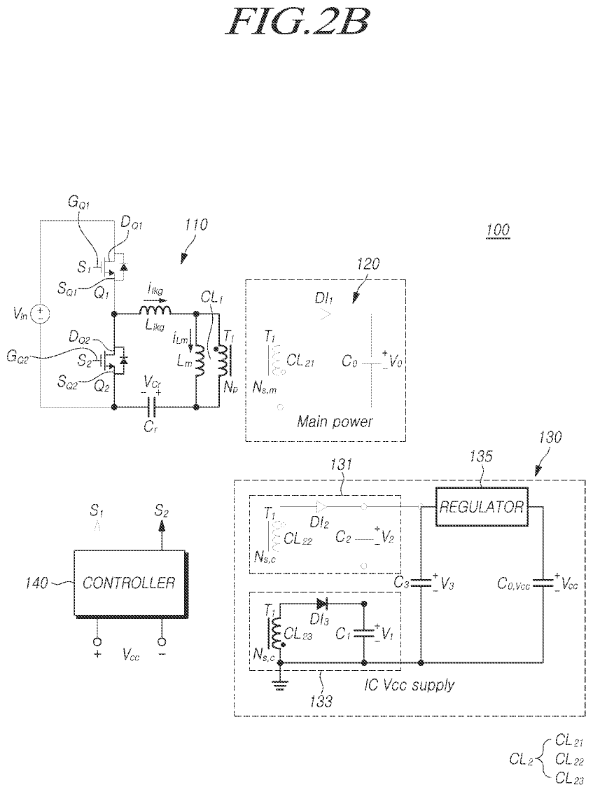

FIG. 1 is a circuit diagram illustrating an example power delivery apparatus 100 according to various embodiments, FIG. 2A is a circuit diagram illustrating an example operation when a first switching element Q₁ is turned on in a power delivery apparatus 100 according to various embodiments, and FIG. 2B is a circuit diagram illustrating an example operation when a second switching element Q₂ is turned on in a power delivery apparatus 100 according to various embodiments.

Referring to FIG. 1, FIG. 2A, and/or FIG. 2B, the power delivery apparatus 100 may step up (e.g., boost or increase) or step down (e.g., reduce or decrease) an input voltage Vᵢₙ to supply output voltages Vo or Vcc having one or more magnitude(s). The input voltage Vᵢₙ may be, for example, a DC voltage in which an alternating current (AC) voltage supplied from an external power source (e.g., a home electric outlet of 220 V) is converted by a converter (e.g., an AC/DC converter). The input voltage Vᵢₙ may be, for example, a DC voltage supplied by an internal power source (e.g., a battery). The input voltage Vᵢₙ may have a constant voltage level.

The power delivery apparatus 100 may be a DC/DC converter. The power delivery apparatus 100 may have a structure capable of controlling a wide output voltage range (e.g., 5V to 48V). For example, a flyback converter, a ringing choke converter, a forward converter, a half-bridge converter, a full-bridge converter, a push-pull converter, or the like may be used as the DC/DC converter. As a typical example, the flyback converter may be configured for use in both a voltage boosting or a voltage step-down, and may be applied to both insulation and non-insulation. Further, it is possible to secure a wide input voltage range.

For example, the power delivery apparatus 100 may include a flyback converter. The flyback converter may include an asymmetrical half-bridge (AHB) flyback converter. The AHB flyback converter is capable of low voltage stress and zero-voltage switching.

The power delivery apparatus 100 may include a transformer T1. The transformer T₁ may step up or step down a voltage using a mutual induction principle of a coil. The transformer T₁ may generate one or more output voltages Vo or Vcc boosted or reduced by a leakage current (i_{lkg}) or a magnetization current (i_{Lm}) due to an input voltage Vᵢₙ.

The transformer T₁ may include one primary coil CL₁ and a plurality of secondary coils CL₂. The number of turns (Nₚ) of the primary coil CL₁ (hereinafter, referred to as a “primary side number of turns”) may be different from the number of turns (N_{s,m} or N_{s,c}) of each of the plurality of secondary coils CL₂ (hereinafter, referred to as a “secondary side number of turns”). The number of turns ratio Nₚ/N_{s,m} or Nₚ/N_{s,c}, which is a ratio of the primary side number of turns Nₚ to the secondary side number of turns N_{s,m} or N_{s,c}, may be an element for determining a magnitude of an output voltage Vo or Vcc. A winding direction of the primary coil CL₁ or a winding direction of the secondary coil CL₂ may also be a factor for determining the magnitude of the output voltage Vo or Vcc. The winding direction may be indicated by a dot marked at either end of the primary coil CL₁ or the secondary coil CL₂. As an example, the magnitude of the output voltage Vo or Vcc may be determined by a magnitude of the input voltage Vᵢₙ and/or a number of turns ratio Nₚ/N_{s,m} or Nₚ/N_{s,c}, which is a ratio of the primary side number of turns Nₚ to the respective secondary side number of turns N_{s,m} or N_{s,c}, of the plurality of secondary coils CL₂₁, CL₂₂, CL₂₃. For example, the magnitude of the output voltage Vo or Vcc may be affected by the winding direction of the primary coil CL₁ or the winding direction of the secondary coil CL₂. The winding direction of the primary coil CL₁ and/or the winding direction of the secondary coil CL₂ may determine the direction of the induced electromotive force in the secondary coil CL₂ due to the current flowing in a predetermined direction in the primary coil CL₁. The direction of the induced electromotive force may determine the direction of the current flowing through the secondary coil CL₂. For example, the polarity of the input voltage Vᵢₙ and the output voltage Vo or Vcc may be the same as each other in a subtractive polarity transformer. In this case, the current in the secondary coil CL₂ may flow in a direction opposite to the direction of the current flowing through the primary coil CL₁. For example, the polarity of the input voltage Vᵢₙ and the output voltage Vo or Vcc may be opposite to each other in an additive polarity transformer. In this case, the current flowing in the secondary coil CL₂ may flow in the same direction as that of the primary coil CL₁.

The power delivery apparatus 100 may include an input-side rectifier 110, an output-side rectifier, and/or a controller (e.g., including various circuitry) 140. The input-side rectifier 110 may include a primary-side input rectifier circuit. The output-side rectifier may include a first driving circuit 120 and/or a second driving circuit 130.

The input-side rectifier 110 may include an input voltage source, a plurality of switching elements (e.g., a first switching element Q₁ or a second switching element Q₂), a plurality of diodes, a leakage inductor L_{lkg}, a magnetization inductor Lₘ, or a resonance capacitor Cᵣ. The leakage current ilkg may flow through the leakage inductor L_{lkg}. A magnetization current i_{Lm} may flow through the magnetization inductor Lₘ. The resonant capacitor Cᵣ may be charged with a voltage V_{Cr}.

Assuming that the resonant capacitor Cᵣ is sufficiently large and the voltage V_{Cr} has a constant magnitude, the voltage Vcr charged in the resonant capacitor Cᵣ may be defined by a current-second balance of the resonant capacitor Cᵣ using the following Equation 1:

$${V}_{Cr} = {DV}_{in} \qquad ( Equation 1 )$$

wherein ‘D’ is an operation duty ratio and ‘Vᵢₙ’ is a magnitude of the input voltage.

The input-side rectifier 110 may be understood to substantially include a primary coil CL₁ of the transformer T₁.

The input-side rectifier 110 may alternately switch a plurality of switching elements (e.g., the first switching element Q₁ or the second switching element Q₂) to change a voltage source (e.g., the input voltage source Vᵢₙ or the voltage V_{Cr} charged to the resonant capacitor Cᵣ) that generates a leakage current i_{lkg} or a magnetization current i_{Lm} of the transformer T₁. When the voltage source is changed, a path through which the leakage current i_{lkg} or the magnetization current i_{Lm} flows may be changed.

The first switching element Q₁ and/or the second switching element Q₂ may be connected in series between a positive electrode (+) and a negative electrode (−) of the input voltage source supplying the input voltage Vᵢₙ. The first switching element Q₁ may be an N-type metal-oxide-semiconductor field-effect transistor (MOS FET). The second switching element Q₂ may be an N-type MOS FET. A drain terminal D_{Q1} of the first switching element Q₁ may be connected to the positive electrode (+) of the input voltage source. The source terminal S_{Q1} of the first switching element Q₁ may be connected to the drain terminal D_{Q2} of the second switching element Q₂. The source terminal S_{Q2} of the second switching element Q₂ may be connected to the negative electrode of the input voltage source. A gate terminal G_{Q1} of the first switching element Q₁ may be electrically connected to the controller 140. A gate terminal G_{Q2} of the second switching element Q₂ may be electrically connected to the controller 140. A first switch control signal S₁ provided from the controller 140 may be input to the gate terminal G_{Q1} of the first switching element Q₁. In this case, the first switching element Q₁ may be turned on or turned off in response to the first switch control signal S₁ input to the gate terminal G_{Q1}. A second switch control signal S2 provided from the controller 140 may be input to the gate terminal G_{Q2} of the second switching element Q₂. In this case, the second switching element Q₂ may be turned on or turned off in response to the second switch control signal S₂ input to the gate terminal G_{Q2}. The first switching element Q₁ and the second switching element Q₂ may be alternately turned on, for example, by the first switch control signal S₁ or the second switch control signal S₂.

One of the two diodes may be connected in a forward direction in a reverse bias direction (e.g., from the source terminal S_{Q1} to the drain terminal D_{Q1}) of the first switching element Q₁. The other one of the two diodes may be connected in a forward direction in a reverse bias direction (e.g., from the source terminal S_{Q2} to the drain terminal D_{Q2}) of the second switching element Q₂.

The leakage inductor L_{lkg} may be configured to connect any point existing between the first switching element Q₁ and the second switching element Q₂ and one side (e.g., the side marked with a dot) of the primary coil CL₁ in series.

The magnetization inductor Lₘ may be connected in parallel with the primary coil CL₁. That is, one side of the magnetization inductor Lₘ is connected to one side (e.g., the side marked with a dot) of the primary coil CL₁, and the other side of the magnetization inductor Lₘ is connected to the other side (e.g., the side not marked with a dot) of the primary coil CL₁.

The resonant capacitor Cᵣ may be connected in series between the source terminal S_{Q2} of the second switching element Q₂ and the other side (e.g., the side not marked with a dot) of the primary coil CL₁.

The controller 140 may include various control circuitry and control a flow of the leakage current i_{lkg} or the magnetization current i_{Lm} at the input-side rectifier 110. To this end, the controller 140 may output a plurality of switching control signals. The plurality of switching control signals may alternately turn on a plurality of switching elements included in the input-side rectifier 110, for example.

The controller 140 may output a first switching control signal S₁ for controlling the operation of the first switching element Q₁ included in the input-side rectifier 110. The controller 140 may output a second switching control signal S₂ for controlling the operation of the second switching element Q₂ included in the input-side rectifier 110. For example, the controller 140 may alternately output the first switching control signal S₁ to turn on the first switching element Q₁ or the second switching control signal S2 to turn on the second switching element Q₂, based on the operation duty ratio D in one switching period. The operation duty ratio D may be, for example, a ratio of a time interval (e.g., a time interval to turn on the first switching element Q₁) corresponding to a high-level state with respect to a time interval Tᵢ corresponding to one switching period Tₛₚ. Hereinafter, the time interval to turn on the first switching element Q₁ may be referred to as a ‘first interval DTᵢ’, and the time interval to turn on the second switching element Q₂ will be referred to as a ‘second interval (1-D)Tᵢ’. Within the time interval Tᵢ corresponding to the one switching period Tₛₚ, there may not exist an interval in which the first interval DTᵢ and the second interval (1-D)Tᵢ substantially overlap each other.

The controller 140 may output the first switching control signal S₁ for turning on the first switching element Q₁ in the first interval DTᵢ included in one switching period Tₛₚ. The controller 140 may output the second switching control signal S₂ for turning off the second switching element Q₂ in the first interval DTᵢ included in one switching period Tₛₚ. However, the disclosure is not limited thereto, and it may be implemented by the opposite operation.

The controller 140 may output the first switching control signal S1 for turning off the first switching element Q₁ in the second interval (1-D)Tᵢ included in one switching period Ts. The controller 140 may output the second switching control signal S₂ for turning on the second switching element Q₂ in the second interval (1-D)Tᵢ included in one switching period Tₛₚ. However, the disclosure is not limited thereto, and it may be implemented by the opposite operation.

The controller 140 may output the first switching control signal S₁ for turning on the first switching element Q₁ and/or the second switching control signal S₂ for turning off the second switching element Q₂, in the first interval DTᵢ included in one switching period Tₛₚ. The first switching control signal S1 may control the first switching element Q₁ such that the first switching element Q₁ is turned on. For example, the first switching control signal S₁ may be input to the gate terminal G_{Q1} of the first switching element Q1 to turn on (or short-circuit) between the drain terminal D_{Q1} and the source terminal S_{Q1} of the first switching element Q₁. The second switching control signal S₂ may control the second switching element Q₂ such that the second switching element Q₂ is turned off. For example, the second switching control signal S₂ may be input to the gate terminal G_{Q2} of the second switching element Q₂ to turn off (or open-circuit) between the drain terminal D_{Q2} and the source terminal S_{Q2} of the second switching element Q₂.

The controller 140 may output the first switching control signal S₁ for turning off the first switching element Q₁ and/or the second switching control signal S₂ for turning on the second switching element Q₂, in the second interval (1-D)Tᵢ included in one switching period Tₛₚ. The first switching control signal S₁ may control the first switching element Q₁ such that the first switching element Q₁ is turned off. For example, the first switching control signal S₁ may be input to the gate terminal G_{Q1} of the first switching element Q₁ to turn off (or open-circuit) between the drain terminal D_{Q1} and the source terminal S_{Q1} of the first switching element Q₁. The second switching control signal S₂ may control the second switching element Q₂ such that the second switching element Q₂ is turned on. For example, the second switching control signal S₂ may be input to the gate terminal G_{Q2} of the second switching element Q₂ to turn on (or short-circuit) between the drain terminal D_{Q2} and the source terminal S_{Q2} of the second switching element Q₂.

The output-side rectifier may generate an internal operating voltage Vcc having a predetermined magnitude and/or a charging supply voltage Vo having a variable magnitude within a predetermined range (e.g., 5 to 48V) by an induced electromotive force in each of a plurality of secondary coils C₂ (e.g. CL₂₁, CL₂₁, CL₂₃) making up the transformer T₁. The output-side rectifier may include a plurality of driving circuits. For example, the output-side rectifier may include a first driving circuit 120 and a second driving circuit 130 for obtaining an output voltage for each use.

The first driving circuit 120 may output the charging supply voltage Vo having a variable magnitude within a predetermined range (e.g., 5 to 48 V). The magnitude of the charging supply voltage Vo may be affected by the turn ratio Nₚ/N_{s,m}, which is a ratio of the number of turns Nₚ of the primary coil CL₁ to the number of turns N_{s,m} of the secondary coil CL₂₁. The charging supply voltage Vo may be used to charge an auxiliary battery including a secondary battery or an electronic device with a built-in secondary battery. The electronic device may include, for example, a portable communication device (e.g., a smartphone), a computer device, a portable multimedia device, a portable medical device, a camera, a wearable device, or a home appliance.

The first driving circuit 120 may include a secondary coil CL₂₁, a diode DI₁, and/or a capacitor C₀. The secondary coil CL₂₁ may have a predetermined number of turns N_{s,m}. The secondary coil CL₂₁ may have a predetermined winding direction. The secondary coil CL₂₁ may have a winding direction different from that of the primary coil CL₁. The number of turns N_{s,m} of the secondary coil CL₂₁ may be different from the number of turns Nₚ of the primary coil CL₁ included in the input-side rectifier 110. The winding direction of the secondary coil CL₂₁ may be different from the winding direction of the primary coil CL₁ included in the input-side rectifier 110. This may be seen by the fact that the position of the dot indicated on the primary coil CL₁ is different from the position of the dot indicated on the secondary coil CL₂₁.

The diode DI₁ may be connected to the capacitor C₀ in a forward direction from one side (e.g., the side not marked with a dot) of the secondary coil CL₂₁. That is, an anode of the diode DI₁ may be electrically connected to one side (e.g., the side not marked with a dot) of the secondary coil CL₂₁, and a cathode of the diode DI₁ may be electrically connected to the capacitor C₀. The capacitor C₀ may be connected in series between the cathode of the diode DI₁ and the other side (e.g., the side marked with a dot) of the secondary coil CL₂₁. The charging supply voltage Vo may be stored in the capacitor C₀ by a current supplied through the diode DI₁. The charging supply voltage Vo stored in the capacitor C₀ may be supplied to charge an electronic device electrically connected for charging. The other side (e.g., the side marked with a dot) of the secondary coil CL₂₁ may be grounded.

The second driving circuit 130 may output an internal operating voltage Vcc. The internal operating voltage Vcc may be used as an operating voltage required to drive an internal chip (such as the controller 140 (e.g., a flyback converter chip)). Preferably, the internal operating voltage Vcc may be maintained at a constant magnitude without being affected by a change in magnitude of the charging supply voltage Vo.

The second driving circuit 130 may include a first direction driving circuit 131, a second direction driving circuit 133, a regulator (e.g., including various circuitry) 135, and/or a plurality of capacitors (C₃, C_{0,Vcc}). The secondary coils CL₂₂ and CL₂₃ of the first direction driving circuit 131 and the second direction driving circuit 133 included in the second driving circuit 130 may have different winding directions. Each of the first direction driving circuit 131 and the second direction driving circuit 133 may be a rectification circuit of a single-ended structure. The first direction driving circuit 131 and the second direction driving circuit 133 may be stacked in series to make up the second driving circuit 130.

The first direction driving circuit 131 may include a secondary coil CL₂₂, a diode DI₂, or a capacitor C₂. The secondary coil CL₂₂ may have a predetermined number of turns N_{s,c}. The secondary coil CL₂₂ may have a predetermined winding direction. The secondary coil CL₂₂ may have the same winding direction as the primary coil CL₁.

The diode DI₂ may be connected to the capacitor C₂ in a forward direction from one side (e.g., the side marked with a dot) of the secondary coil CL₂₂. That is, an anode of the diode DI₂ may be electrically connected to one side (e.g., the side marked with a dot) of the secondary coil CL₂₂, and a cathode of the diode DI₂ may be electrically connected to the capacitor C₂. The capacitor C₂ may be connected in series between the cathode of the diode DI₂ and the other side (e.g., the side not marked with a dot) of the secondary coil CL₂₂. A second operating voltage V₂ may be stored in the capacitor C₂ by a current supplied through the diode DI₂ due to an induced electromotive force in the secondary coil CL₂₂. The second operating voltage V₂ stored in the capacitor C₂ may be used as an internal operating voltage Vcc for driving an internal chip (such as the controller 140 (e.g., a flyback converter chip)).

The second operating voltage V₂ may be defined by the following Equation 2:

$${V}_{2} = \frac{{L}_{m}}{{L}_{m} + {L}_{lkg}} ( 1 - D ) \frac{{N}_{s , c} {V}_{in}}{{N}_{p}} \qquad ( Equation 2 )$$

wherein Lₘ is a magnetization inductance, L_{lkg} is a leakage inductance, D is an operation duty ratio, N_{s,c} is the number of turns of the secondary coil CL₂₂ of the first direction driving circuit 131, Vᵢₙ is a magnitude of the input voltage, and Nₚ is the number of turns of the primary coil CL₁.

The second direction driving circuit 133 may include a secondary coil CL₂₃, a diode DI₃, or a capacitor C₁. The secondary coil CL₂₃ may have a predetermined number of turns N_{s,c}. The secondary coil CL₂₃ may have a predetermined winding direction. The secondary coil CL₂₃ may have a winding direction different from that of the primary coil CL₁. That is, the secondary coil CL₂₃ may have the same winding direction as the secondary coil CL₂₁.

The diode DI₃ may be connected to the capacitor C₁ in a forward direction from one side (e.g., the side not marked with a dot) of the secondary coil CL₂₃. That is, an anode of the diode DI₃ may be electrically connected to one side (e.g., the side not marked with a dot) of the secondary coil CL₂₃, and a cathode of the diode DI₃ may be electrically connected to the capacitor C₁. The capacitor C₁ may be connected in series between the cathode of the diode DI₃ and the other side (e.g., the side marked with a dot) of the secondary coil CL₂₃. A first operating voltage V₁ may be stored in the capacitor C₁ by a current supplied through the diode DI₃ due to an induced electromotive force in the secondary coil CL₂₃. The first operating voltage V₁ stored in the capacitor C₁ may be used as an internal operating voltage Vcc for driving an internal chip (such as the controller 140 (e.g., a flyback converter chip)). The other side (e.g., the side marked with a dot) of the secondary coil CL₂₃ may be grounded.

The first operating voltage V₁ may be defined by the following Equation 3:

$${V}_{1} = \frac{{L}_{m}}{{L}_{m} + {L}_{lkg}} D \frac{{N}_{s , c} {V}_{in}}{{N}_{p}} \qquad ( Equation 3 )$$

wherein Lₘ is a magnetization inductance, L_{lkg} is a leakage inductance, D is an operation duty ratio, N_{s,c} is the number of turns of the secondary coil CL₂₃ of the second direction driving circuit 133, Vᵢₙ is a magnitude of the input voltage, and Nₚ is the number of turns of the primary coil CL₁.

The capacitor C₃, which is one of the plurality of capacitors (C₃, C_{0,Vcc}), may be connected between the first direction driving circuit 131 and the second direction driving circuit 133. The capacitor C₃ may be charged with a voltage V₃ obtained by adding the second operating voltage V₂ stored in the capacitor C₂ included in the first direction driving circuit 131 and the first operating voltage V₁ stored in the capacitor C₁ included in the second direction driving circuit 133.

The voltage V₃ charged in the capacitor C₃ may be then defined by the following Equation 4:

$${V}_{3} = \frac{{L}_{m}}{{L}_{m} + {L}_{lkg}} \frac{{N}_{s , c} {V}_{in}}{{N}_{p}} = \frac{{N}_{p} {V}_{in}}{{N}_{s , c}} \qquad ( Equation 4 )$$

wherein Lₘ is a magnetization inductance, L_{lkg} is a leakage inductance, N_{s,c} is the number of turns of the secondary coils (CL₂₂, CL₂₃) of the first or second direction driving circuits 131 and 133, Vᵢₙ is a magnitude of the input voltage, and Nₚ is the number of turns of the primary coil CL₁.

According to the Equation 4 above, the voltage V₃ stored in the capacitor C₃ to be used as an internal operating voltage Vcc may be obtained regardless of the charging supply voltage Vo of which magnitude may vary depending on the situation. That is, since the voltage V₃ stored in the capacitor C₃ may be controlled to a constant value in proportion to the input voltage Vᵢₙ, a constant internal operating voltage Vcc may be supplied.

The regulator 135 may receive the voltage V₃ charged in the capacitor C₃ to stably output a constant magnitude of internal operating voltage Vcc. The regulator 135 may be a linear regulator. The regulator 135 may be a switching regulator. The capacitor C₃ may be stably charged with a constant magnitude of voltage V₃ regardless of variation of the charging supply voltage Vo, and therefore, the regulator 135 may achieve power consumption in its manageable range of regulation.

The capacitor C_{0,Vcc}, which is one of the plurality of capacitors (C₃, C_{0,Vcc}), may store a voltage stably supplied at a certain level through the regulator 135. The voltage stored by the capacitor C_{0,Vcc} may be supplied to the operating voltage Vcc of the controller 140.

The number of turns N_{s,c} of the secondary coil CL₂₂ included in the first direction driving circuit 131 may be different from the number of turns Nₚ of the primary coil CL₁ included in the input-side rectifier 110. The number of turns N_{s,c} of the secondary coil CL₂₃ included in the second direction driving circuit 133 may be different from the number of turns Nₚ of the primary coil CL₁ included in the input-side rectifier 110. The number of turns N_{s,c} of the secondary coil CL₂₂ included in the first direction driving circuit 131 may be different from the number of turns N_{s,m} of the secondary coil CL₂₁ included in the first driving circuit 120. The number of turns N_{s,c} of the secondary coil CL₂₃ included in the second direction driving circuit 133 may be different from the number of turns N_{s,m} of the secondary coil CL₂₁ included in the first driving circuit 120. The number of turns N_{s,c} of the secondary coil CL₂₂ included in the first direction driving circuit 131 may be the same as the number of turns N_{s,c} of the secondary coil CL₂₃ included in the second direction driving circuit 133.

The winding direction of the secondary coil CL₂₂ included in the first direction driving circuit 131 may be the same as the winding direction of the primary coil CL₁ included in the input-side rectifier 110. The winding direction of the secondary coil CL₂₃ included in the second direction driving circuit 133 may be different from the winding direction of the primary coil CL₁ included in the input-side rectifier 110. The winding direction of the secondary coil CL₂₂ included in the first direction driving circuit 131 may be different from the winding direction of the secondary coil CL₂₁ included in the first driving circuit 120. The winding direction of the secondary coil CL₂₃ included in the second direction driving circuit 133 may be the same as the winding direction of the secondary coil CL₂₁ included in the first driving circuit 120. The winding direction of the secondary coil CL₂₂ included in the first direction driving circuit 131 may be different from the winding direction of the secondary coil CL₂₃ included in the second direction driving circuit 133. It may be seen by the fact that a position of a dot indicated on the secondary coil CL₂₂ included in the first direction driving circuit 131 is different from a position of a dot indicated on the secondary coil CL₂₃ included in the second direction driving circuit 133.

The first direction driving circuit 131 or the second direction driving circuit 133 may alternately output the first or second operating voltage V₁ or V₂ in response to a switching operation of the first switching element Q₁ or the second switching element Q₂ included in the input-side rectifier 110. For example, in a time interval DTᵢ in which the first switching element Q₁ is turned on and the second switching element Q₂ is turned off (wherein ‘D’ is an operation duty ratio and ‘Tₛₚ’ is a switching period), the first direction driving circuit 131 may output the second operation voltage V₂ (see FIG. 2A). In this case, the second direction driving circuit 133 may not substantially output the first operating voltage V₁. For example, in a time interval (1-D)Tᵢ where the first switching element Q₁ is turned off and the second switching element Q₂ is turned on, the second direction driving circuit 133 may output the first operating voltage V₁ (see FIG. 2B). In this case, the first direction driving circuit 131 may not substantially output the second operating voltage V₂.

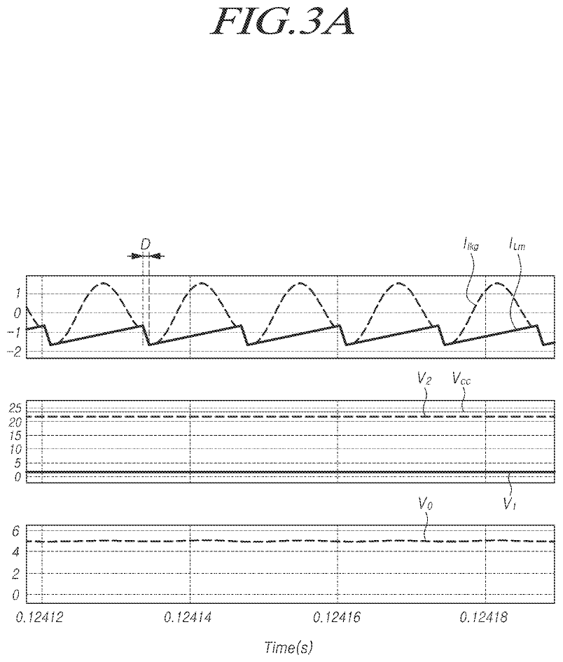

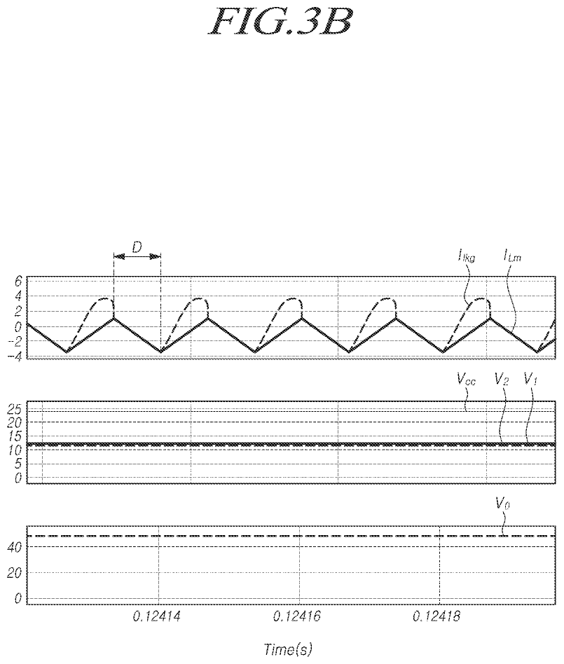

FIG. 3A includes example waveform diagrams illustrating an example operation simulation for obtaining a low charging supply voltage Vo in a power delivery apparatus (e.g., the power delivery apparatus 100 of FIG. 1), according to various embodiments, and FIG. 3B includes example waveform diagrams illustrating an example operation simulation for obtaining a high charging supply voltage Vo in a power delivery apparatus 100, according to various embodiments.

Referring to FIG. 3A or FIG. 3B, the power delivery apparatus 100 may determine the operation duty ratio D in consideration of a charging supply voltage Vo to be obtained within a predetermined range (e.g., 5V to 48V). For example, the power delivery apparatus 100 may determine the operation duty ratio D in proportion to the charging supply voltage Vo to be obtained. For example, the operation duty ratio D determined to obtain the charging supply voltage Vo of 5 V may be relatively lower than the operation duty ratio D determined to obtain the charging supply voltage Vo of 48 V. The operation duty ratio D, which may be varied in consideration of the charging supply voltage Vo to be obtained, is to allow a substantially constant internal operating voltage Vcc to be outputted regardless of a change in the charging supply voltage Vo. The operation duty ratio D may control the magnitudes of the first operation voltage V₁ and the second operation voltage V₂ to determine the internal operation voltage Vcc.

When the charging supply voltage Vo to be obtained is relatively low, such as e.g., 5V, the power delivery apparatus 100 may apply a shorter operation duty ratio D. As described above, as the operation duty ratio D decreases, the first operation voltage V₁ (e.g., the voltage charged to the capacitor C₁ included in the second direction driving circuit 133 of FIG. 1) decreases, while the second operation voltage V₂ (e.g., the voltage charged to the capacitor C₂ included in the first direction driving circuit 131 of FIG. 1) increases, and thus a constant internal operating voltage Vcc may be outputted (see FIG. 3A).

When the charging supply voltage Vo to be obtained is relatively high, such as e.g., 48V, the power delivery apparatus 100 may apply a longer operation duty ratio D. As described above, as the operation duty ratio D increases, the first operation voltage V₁ (e.g., the voltage charged to the capacitor C₁ included in the second direction driving circuit 133 of FIG. 1) may increase, while the second operation voltage V₂ (e.g., the voltage charged to the capacitor C₂ included in the first direction driving circuit 131 of FIG. 1) may decrease, and thus a constant internal operating voltage Vcc may be outputted (see FIG. 3B).

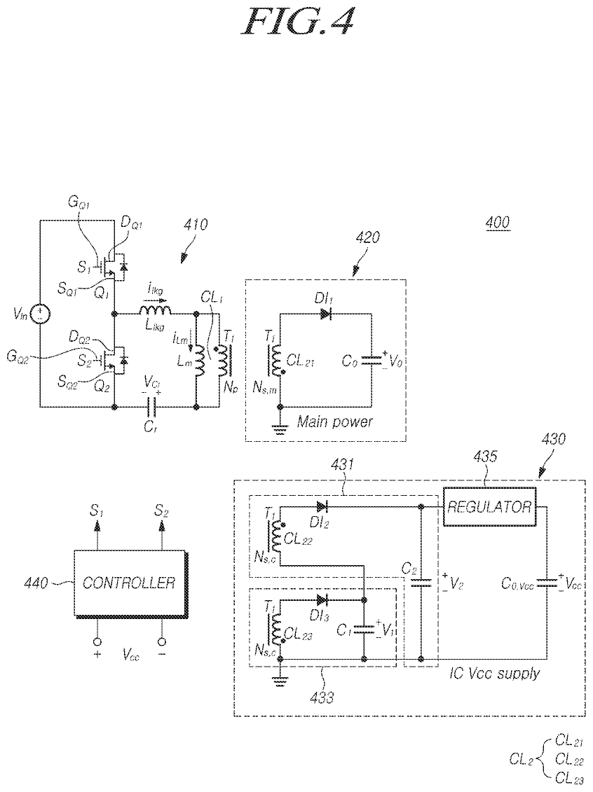

FIG. 4 is a circuit diagram illustrating an example power delivery apparatus 400 according to various embodiments.

Referring to FIG. 4, the power delivery apparatus 400 may include an input-side rectifier 410, an output-side rectifier, and/or a controller (e.g., including various circuitry) 440. The output-side rectifier may include a first driving circuit 420 and/or a second driving circuit 430. The input-side rectifier 410 may have substantially the same structure or operation as the input-side rectifier 110 included in the power delivery apparatus 100 illustrated in FIG. 1. The controller 440 may perform substantially the same operation as the controller 140 included in the power transmission apparatus 100 illustrated in FIG. 1. The first driving circuit 420 may have substantially the same structure or operation as the first driving circuit 120 included in the power delivery apparatus 100 illustrated in FIG. 1. However, the second driving circuit 430 may be different in structure or operation from the second driving circuit 130 included in the power delivery apparatus 100 illustrated in FIG. 1. For example, the structure or operation of the first direction driving circuit 431, included in the second driving circuit 430, may be different from that of the first direction driving circuit 131 of FIG. 1. In addition, the second driving circuit 430 does not include the capacitor C3 included in the second driving circuit 130 of the power delivery apparatus 100 illustrated in FIG. 1.

The second driving circuit 430 may include a first direction driving circuit 431, a second direction driving circuit 433, a regulator (e.g., including various circuitry) 435, and/or capacitor C_{0,Vcc}.

The first direction driving circuit 431 may include a secondary coil CL₂₂, a diode DI₂, or a capacitor C₂. The secondary coil CL₂₂ may have a predetermined number of turns N_{s,c}. The secondary coil CL₂₂ may have a predetermined winding direction. The secondary coil CL₂₂ may have the same winding direction as the primary coil CL₁.

The diode DI₂ may be connected to the capacitor C₂ in a forward direction from one side (e.g., the side marked with a dot) of the secondary coil CL₂₂. That is, an anode of the diode DI₂ may be electrically connected to one side (e.g., the side marked with a dot) of the secondary coil CL₂₂, and a cathode of the diode DI₂ may be electrically connected to the capacitor C₂. The capacitor C₂ may be connected in series between a cathode of the diode DI₂ and one side (e.g., the side marked with a dot) of the secondary coil CL₂₃. A second operating voltage V₂ may be stored in the capacitor C₂ by a current supplied through the diode DI₂ due to an induced electromotive force in the secondary coil CL₂₂. The second operating voltage V₂ stored in the capacitor C₂ may be used as an internal operating voltage Vcc for driving an internal chip (such as the controller 140 (e.g., a flyback converter chip)). The second operating voltage V₂ charged in the capacitor C₂ may be defined to be the same as the voltage V₃ defined by the Equation 3 above.

The regulator 435 may be supplied with the second operating voltage V₂ charged in the capacitor C₂ to stably output the internal operating voltage Vcc of a constant magnitude. The regulator 435 may be a linear regulator. The regulator 435 may be a switching regulator. Since the capacitor C₂ may be stably charged with the second operating voltage V₂ of a constant magnitude regardless of variation of the charging supply voltage Vo, the regulator 435 may achieve power consumption in a manageable range.

The capacitor C_{0,Vcc} may store a voltage stably supplied at a constant magnitude through the regulator 435. The voltage stored by the capacitor C_{0.Vcc} may be supplied to the operating voltage Vcc of the controller 440.

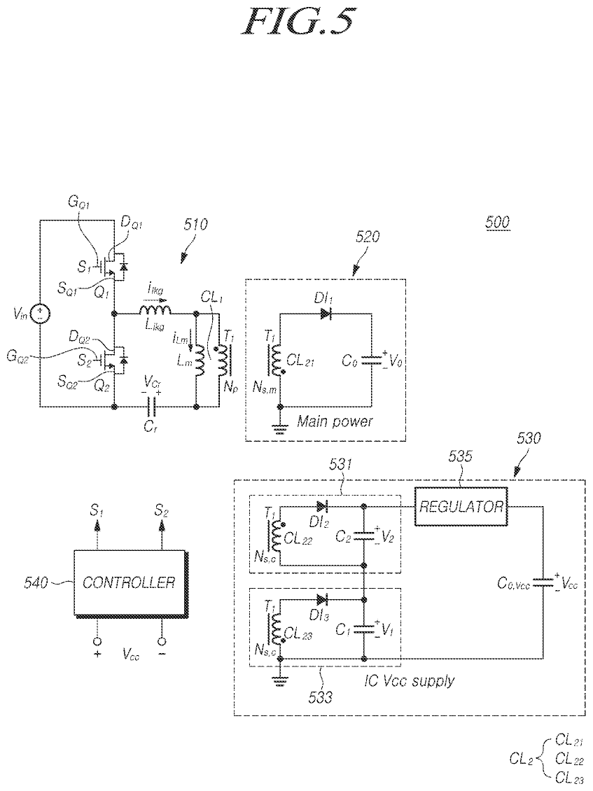

FIG. 5 is a circuit diagram illustrating an example power delivery apparatus 500 according to various embodiments.

Referring to FIG. 5, the power delivery apparatus 500 may include an input-side rectifier 510, an output-side rectifier, and/or a controller (e.g., including various circuitry) 540. The output-side rectifier may include a first driving circuit 520 or a second driving circuit 530. The input-side rectifier 510 may have substantially the same structure or operation as the input-side rectifier 110 included in the power delivery apparatus 100 illustrated in FIG. 1. The controller 540 may perform substantially the same operation as the controller 140 included in the power transmission apparatus 100 illustrated in FIG. 1. The first driving circuit 520 may have substantially the same structure or operation as the first driving circuit 120 included in the power delivery apparatus 100 illustrated in FIG. 1. However, the second driving circuit 530 may be different in structure or operation from the second driving circuit 130 included in the power delivery apparatus 100 illustrated in FIG. 1. For example, the second driving circuit 530 does not include the capacitor C₃ included in the second driving circuit 130 of the power delivery apparatus 100 illustrated in FIG. 1.

The second driving circuit 530 may include a first direction driving circuit 531, a second direction driving circuit 533, a regulator 535, or a capacitor C_{0,Vcc}.

The regulator 535 may be supplied with the second operating voltage V₂ charged in the capacitor C₂ included in the first direction driving circuit 531 and the first operating voltage V₁ charged in the capacitor C₁ included in the second direction driving circuit 533 to stably output the internal operating voltage Vcc of a constant magnitude. The regulator 535 may be a linear regulator. The regulator 535 may be a switching regulator. Since the capacitor C₂ and the capacitor C₁ may be stably charged with the first and second operating voltages (V₁, V₂) of a constant magnitude irrespectively of variation in the charging supply voltage Vo, the regulator 535 may achieve power consumption in a manageable range.

The capacitor C_{0,Vcc} may store a voltage that is stably supplied at a constant magnitude through the regulator 535. The voltage stored by the capacitor C_{0,Vcc} may be supplied as the operating voltage Vcc of the controller 540.

The following Table 1 illustrates voltage stress for each capacitor in each of the power delivery apparatus 100 shown in FIG. 1, the power delivery apparatus 400 shown in FIG. 4, or the power delivery apparatus 500 shown in FIG. 5.

TABLE 1

| | FIG. 1 | FIG. 4 | FIG. 5 |
|---|---|---|---|
| C₁ | DVo*N_{s, c}/N_{s, m} | DVo*N_{s, c}/N_{s, m} | DVo*N_{s, c}/N_{s, m} |
| C₂ | (1 − D)Vo*N_{s, c}/N_{s, m} | Vo*N_{s, c}/N_{s, m} | (1 − D) Vo*N_{s, c}/N_{s, m} |
| C₃ | Vo*N_{s, c}/N_{s, m} | — | — |

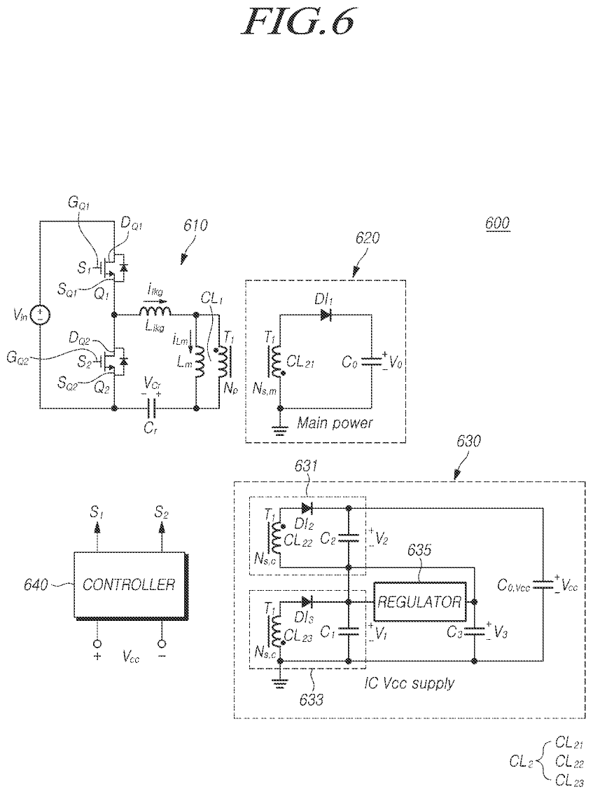

FIG. 6 is a circuit diagram illustrating an example power delivery apparatus 600 according to various embodiments.

Referring to FIG. 6, the power delivery apparatus 600 may include an input-side rectifier 610, an output-side rectifier, and/or a controller (e.g., including various circuitry) 640. The output-side rectifier may include a first driving circuit 620 or a second driving circuit 630. The input-side rectifier 610 may have substantially the same structure or operation as the input-side rectifier 110 included in the power delivery apparatus 100 illustrated in FIG. 1. The controller 640 may perform substantially the same operation as the controller 140 included in the power transmission apparatus 100 illustrated in FIG. 1. The first driving circuit 620 may have substantially the same structure or operation as the first driving circuit 120 included in the power delivery apparatus 100 illustrated in FIG. 1. However, the second driving circuit 630 may be different in structure or operation from the second driving circuit 130 included in the power delivery apparatus 100 illustrated in FIG. 1. For example, in the second driving circuit 130 of the power delivery apparatus 100 illustrated in FIG. 1, the regulator 135 is provided at the output terminal of the internal operating voltage Vcc, while in FIG. 6, the regulator 635 is provided at an output terminal of the second direction driving circuit 633 at the output terminal at which the first operating voltage V₁ charged in the capacitor C₁ included in the second direction driving circuit 633 is output. In this case, the feedback of the regulator 635 may be constantly controlled by receiving the internal driving voltage Vcc, and therefore, the voltage stress of the switch used in the regulator 635 may be reduced.

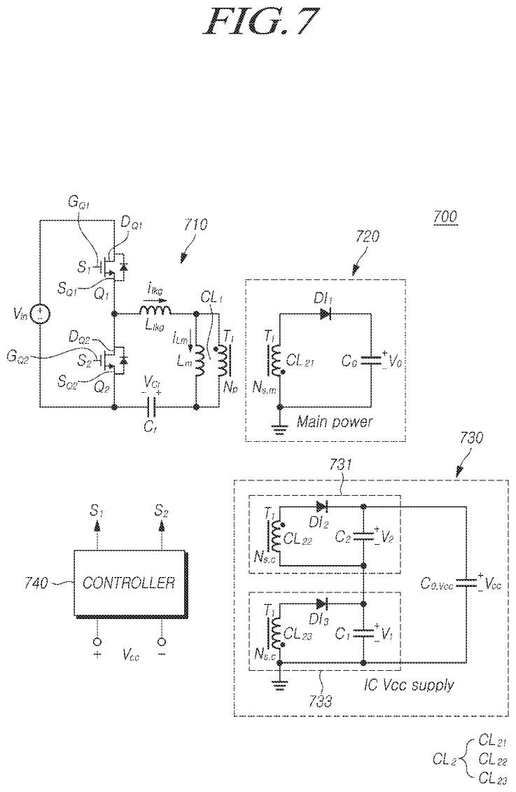

FIG. 7 is a circuit diagram illustrating an example power delivery apparatus 700 according to various embodiments.

The power delivery apparatus 700 illustrated in FIG. 7 may include an input-side rectifier 710, an output-side rectifier, and/or a controller (e.g., including various circuitry) 740. The output-side rectifier may include a first driving circuit 720 or a second driving circuit 730. The input-side rectifier 710 may have substantially the same structure or operation as the input-side rectifier 110 included in the power delivery apparatus 100 illustrated in FIG. 1. The controller 740 may perform substantially the same operation as the controller 140 included in the power transmission apparatus 100 illustrated in FIG. 1. The first driving circuit 720 may have substantially the same structure or operation as the first driving circuit 120 included in the power delivery apparatus 100 illustrated in FIG. 1. However, the second driving circuit 730 may be different in structure or operation from the second driving circuit 130 included in the power delivery apparatus 100 illustrated in FIG. 1. For example, the second driving circuit 130 of the power delivery apparatus 100 illustrated in FIG. 1 includes the regulator 135, but the second driving circuit 730 of FIG. 7 does not include a regulator.

If the input voltage Vᵢₙ does not change when the power delivery apparatus 700 illustrated in FIG. 7 does not include the regulator, the power delivery apparatus 700 may constantly output the internal operating voltage Vcc regardless of the charging supply voltage Vo.

Although the direct-current supply device according to various embodiments of the disclosure has been described based on an AHB flyback converter, it may not only be equally applicable to other type of flyback converters (e.g., a resistor-capacitor-diode flyback converter, an active clamp flyback converter, or a two-switch flyback converter) but also may stably supply a constant internal operating voltage Vcc based on similar operations.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled to the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, “logic”, “logic block”, “part”, or “circuitry”. A module may be a single integral component, or a minimum unit or part thereof, adapted to perform one or more functions. For example, according to an embodiment, the module may be implemented in a form of an application-specific integrated circuit (ASIC).

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. A power delivery (PD) apparatus, comprising:
A primary-side input rectification circuit configured such that a current flows through a primary coil by alternately operating at least two switching elements, comprising at least one switch, according to a magnitude of a charging supply voltage to be obtained;
a first driving circuit configured to output the charging supply voltage by an induced electromotive force due to a current flowing through the primary coil; and
a second driving circuit configured to output an internal operating voltage by the induced electromotive force due to the current flowing through the primary coil,
wherein the second driving circuit includes secondary coils having different winding directions and is configured such that a plurality of rectification circuits are coupled in a form stacked in series.

2. The power delivery apparatus of claim 1, wherein the plurality of rectification circuits have a single-ended structure.

3. The power delivery apparatus of claim 1, wherein the plurality of rectification circuits comprise:
a first direction driving circuit including a secondary coil having a different winding direction from a secondary coil included in the first driving circuit, and
a second direction driving circuit including a secondary coil having a same winding direction as the secondary coil included in the first driving circuit.

4. The power delivery apparatus of claim 3, wherein the second driving circuit comprises a third capacitor configured to be charged with a voltage corresponding to a sum of a voltage charged in the first capacitor included in the first direction driving circuit and a voltage charged in the second capacitor included in the second direction driving circuit.

5. The power delivery apparatus of claim 4, wherein the second driving circuit comprises a regulator, comprising circuitry, configured to output the voltage charged in the third capacitor to the internal operating voltage of a constant magnitude.

6. The power delivery apparatus of claim 1, further comprising:
a controller, comprising circuitry, configured to: receive the internal operating voltage from the second driving circuit and output switching control signals to alternately operate the at least two switching elements included in the primary-side input rectification circuit.

7. The power delivery apparatus of claim 6, wherein the controller is configured to determine an operation duty ratio in proportion to a magnitude of the charging supply voltage and output switching control signals to adjust a turn-on time interval of each of the at least two switching elements based on the determined operation duty ratio.

8. The power delivery apparatus of claim 7, wherein the controller is configured to:
increase the operation duty ratio based on the magnitude of the charging supply voltage increasing, and decrease the operation duty ratio based on the magnitude of the charging supply voltage decreasing.

9. The power delivery apparatus of claim 1, wherein the secondary coils have a same number of turns.

10. The power delivery apparatus of claim 1, wherein the plurality of rectification circuits are configured such that diodes and capacitors connected in a forward direction on a closed loop connecting both sides of the secondary coils are connected in series.

11. A power delivery (PD) apparatus of a universal serial bus (USB), comprising:
a flyback converter configured to use an input voltage to output a variable charging supply voltage within a specified range, and an operating voltage having a constant magnitude; and
a flyback converter chip, comprising circuitry, configured to use the operating voltage to drive the flyback converter,
wherein the flyback converter comprises a transformer including a primary coil and a plurality of secondary coils, and rectification circuits having a same structure electrically connected to each of the plurality of secondary coils; and
wherein the flyback converters are configured such that voltages obtained in parallel by the two rectification circuits electrically connected to two secondary coils having the same number of turns and opposite winding directions, among the plurality of secondary coils, are added to be output as the operating voltage.

12. The power delivery apparatus of claim 11, wherein the two rectification circuits have a single-ended structure.

13. The power delivery apparatus of claim 11, wherein the two rectification circuits comprise:
a second rectification circuit including a secondary coil having a winding direction opposite to a winding direction of a secondary coil to which a first rectification circuit configured to output the charging supply voltage among the rectification circuits is electrically connected; and
a third rectification circuit including a secondary coil having a same winding direction as the winding direction of the secondary coil to which the first rectification circuit is electrically connected.

14. The power delivery apparatus of claim 11, further comprising:
a third capacitor configured such that a voltage is charged with voltages obtained in parallel by the two rectification circuits.

15. The power delivery apparatus of claim 14, further comprising:
a regulator configured to output the voltage charged in the third capacitor as the operating voltage having a constant magnitude.

16. The power delivery apparatus of claim 11, wherein the flyback converter chip is configured to output switching control signals to alternately operate at least two switching elements configured in the flyback converters to supply current to the primary coil, using the input voltage.

17. The power delivery apparatus of claim 16, wherein the flyback converter chip is configured to determine an operation duty ratio in proportion to a magnitude of the charging supply voltage and output the switching control signals to adjust a turn-on time interval of each of the at least two switching elements based on the determined operation duty ratio.

18. The power delivery apparatus of claim 17, wherein the flyback converter chip is configured to: increase the operation duty ratio based on the magnitude of the charging supply voltage increasing and decrease the operation duty ratio based on the magnitude of the charging supply voltage decreasing.

19. The power delivery apparatus of claim 11, wherein the secondary coils have a same number of turns.

20. The power delivery apparatus of claim 11, wherein the two rectification circuits are configured such that diodes and capacitors connected in a forward direction on a closed loop connecting both sides of the secondary coils are connected in series.
